(19) United States
(12) Patent Application Publication
(10) Pub. No.: US 2012/0168996 A1
(43) Pub. Date: Jul. 5, 2012

(54) UNIVERSAL CUTTING TORCH AND CUTTING TORCH HEAD

(75) Inventor: Randy C. Edenfield, Lula, GA (US)

(73) Assignee: LINCOLN GLOBAL, INC., City of Industry, CA (US)

(21) Appl. No.: 12/982,763

(22) Filed: Dec. 30, 2010

(51) Int. Cl. B23K 7/00

(52) U.S. Cl. 266/48

(57) ABSTRACT

A universal cutting torch is provided which has a cutting torch head with a universal cavity capable of accommodating any one of a plurality of different torch tips manufactured for different cutting torches having different cavity configurations.

### BACKGROUND OF THE INVENTION

1. Field of the Invention

Devices, systems, and methods consistent with the invention relate to gas cutting torches.

2. Description of the Related Art

Fuel gas-oxygen cutting torches generally comprise a torch head having outlet passages communicating with a torch tip through which a combustible gaseous mixture flows and is ignited and directed toward a workpiece to be cut. The torch further includes fuel gas and oxygen supply lines connected to corresponding sources of fuel gas and oxygen, and valves are provided for controlling the flow of fuel gas and oxygen to the torch head. The torch head typically comprises both a cutting tip and a mixer. The mixer comprises channels which correspond to the outlet passages of the torch head and these channels direct the gasses (fuel gas an oxygen) to a torch tip, also having channels such that, when assembled, the mixer channels correspond to the torch tip channels. It is through the use of the channels in the mixer and the torch tip that the gases (fuel gas and oxygen) are mixed in the appropriate ways to facilitate cutting. During cutting operations, the torch tip is often damaged, requiring frequent replacement.

There are many different manufacturers of cutting torches. To date each different manufacture has developed a cutting torch having a specific cutting head, mixer and torch tip configuration such that torch tips from different manufacturers can not be used with the mixers/cutting heads of other manufacturers. That is, to replace a torch tip it was necessary to use a torch tip specifically designed for that cutting torch. This was typically done to ensure that a user had to purchase a replacement tip from the manufacturer of the torch. This is disadvantageous as it often limits the accessibility to replacement torch tips or requires those having multiple brands of cutting torches to maintain an inventory of many different types of torch tips and mixers.

### BRIEF SUMMARY OF THE INVENTION

An exemplary embodiment of the present invention is a cutting torch, having a torch head where the torch head has a torch head body having a universal cavity and a plurality of channels coupled to the universal cavity. The torch head also has one of a plurality of mixers inserted into a bottom portion of the universal cavity and one of a plurality of torch tips inserted into an upper portion of the universal cavity and abutted against the one of the plurality of mixers. Each of the plurality of torch tips has a unique exterior structural configuration because at least some of the plurality of torch tips were manufactured for use in a second cutting torch having a second cutting head body which has a different cavity from the universal cavity.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a diagrammatical representation of an exemplary embodiment of a cutting torch of the present invention;

FIG. 2 illustrates a diagrammatical representation of an exemplary embodiment of the cutting torch head shown in FIG. 1; and

FIGS. 3-7 illustrates diagrammatical representations of exemplary embodiments of a cutting torch head in accordance with the present invention, employing different cutting torch tips.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

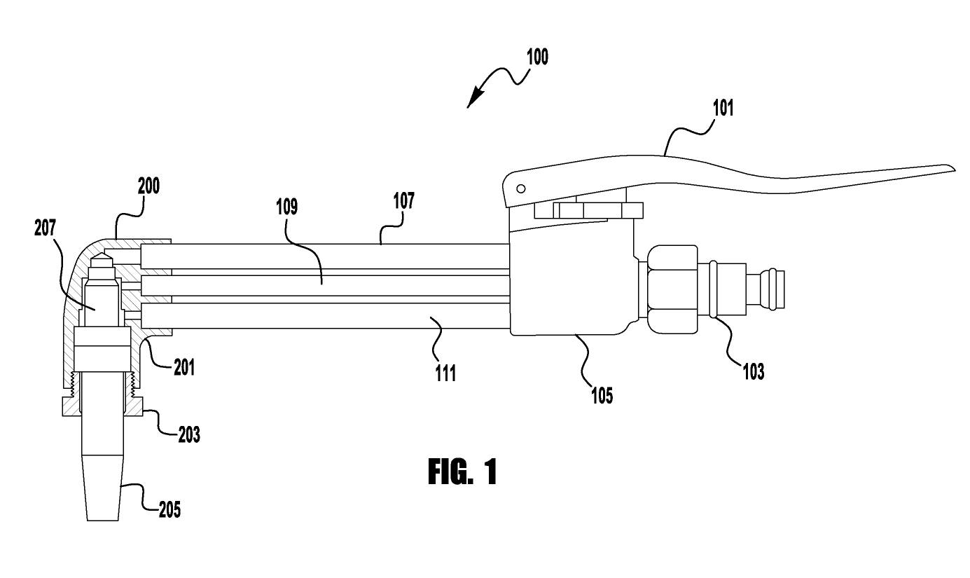

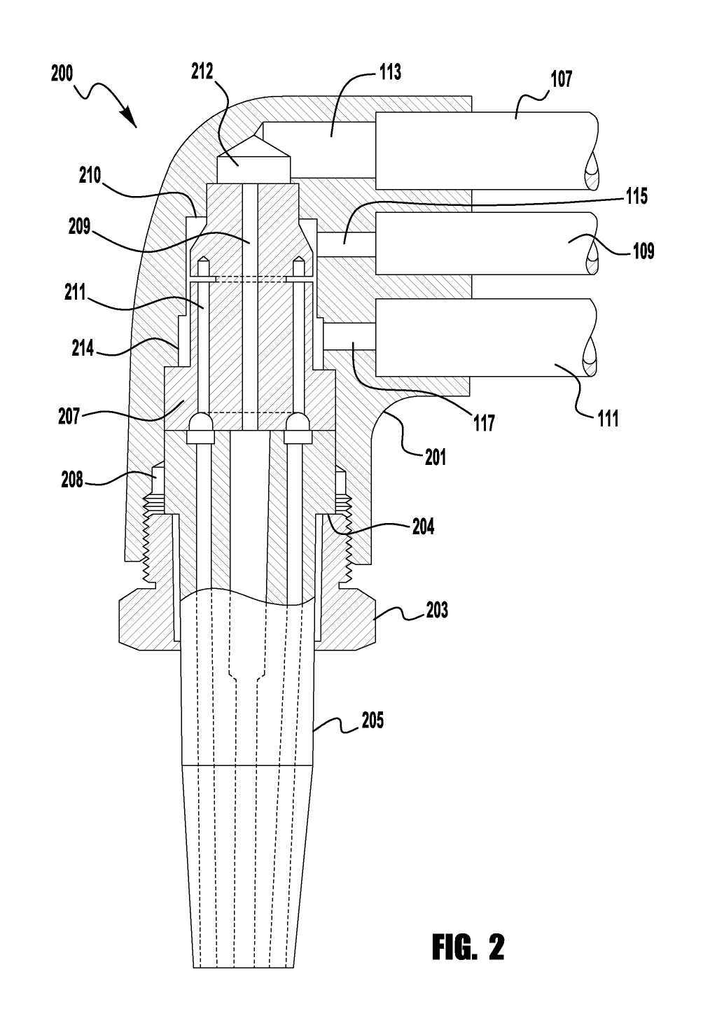

FIGS. 1 and 2 depict a representative embodiment of a cutting torch 100 in accordance with an exemplary embodiment of the present invention. The cutting torch 100 comprises a valve operating lever 101 coupled to a valve housing 105. Interior to the valve housing 105 is a valve structure (not shown) which is operated by the handle 101. As the handle is depressed the valve controls the flow of gas/oxygen in the cutting torch 100. Coupled to the valve is a valve coupling 103 which coupled the valve and torch 100 to gas/oxygen sources (such as tanks) which provide the cutting gas/oxygen to the torch 100. The torch 100 also contains a torch head 200 (see also FIG. 2) which is coupled to the valve and valve housing 105 via a burning oxygen tube 107, a preheat oxygen tube 109 and a fuel gas tube 111. The operation and function of each of these tubes are well known and will not be discussed in detail herein. Further, embodiments of the present invention are not limited to the configuration of the tubes as shown in FIGS. 1 and 2, as the tubes can be configured in a triangular formation, or other suitable configuration.

Coupled to the tubes is a torch head 200. The torch head 200 comprises, generally, a universal torch head body 201, a mixer 207, a torch tip 205 and a torch tip nut 203. The mixer 207 and at least a portion of the torch tip 205 are inserted into a cavity 208 within the torch head 201. The function and operation of the torch head body 201, mixer 207, torch tip 205 and torch tip 205 are well known. For further explanation, the entire disclosure of U.S. Pat. No. 5,688,469 is incorporated herein in its entirety.

The torch head body 201 comprises a plurality of channels 113, 115, and 117 which couple the tubes 107, 109 and 111 to the mixer 207, respectively. The channels 113, 115, and 117 deliver the oxygen/fuel gas from the tubes to the mixer 207. The mixer 207 comprises a cutting oxygen channel 209 which delivers the cutting oxygen from the tube 113, to the torch tip 205. The mixer 207 further comprises outlet passages 211 which are coupled both the preheat oxygen tube 109 (through channel 115) and the fuel gas tube 111 (through channel 117). Both the channel 209 and passages 211 in the mixer 207 are designed to couple with channels in the torch tip 205 to deliver the gases as need for the cutting operation of the torch 100. The passages in the torch tip 205 are typically a function of the manufacturer of the torch tip 205, and is not consistent between manufacturers. That is, in prior art cutting torches only the specific torch tip and mixer configuration designed for that manufacturer's cutting torch can be utilized in that manufacturer's cutting torch.

In embodiments of the present invention, the cavity 208 is designed such that it is universal to the torch tips 205 manufactured by or for multiple manufacturer's respective cutting torches. That is, in embodiments of the present invention the cavity is capable of accommodating various different torch tip configurations without modification to the cavity 208. Because of this, the cutting torch 100 of the present invention can be operated without the need of stocking specific torch tips. Rather, because of aspects of the present invention a single cutting torch 100 can be used with torch tips 205 manufactured for cutting torches from other manufacturers, thus greatly expanding the usability of the cutting torch 100.

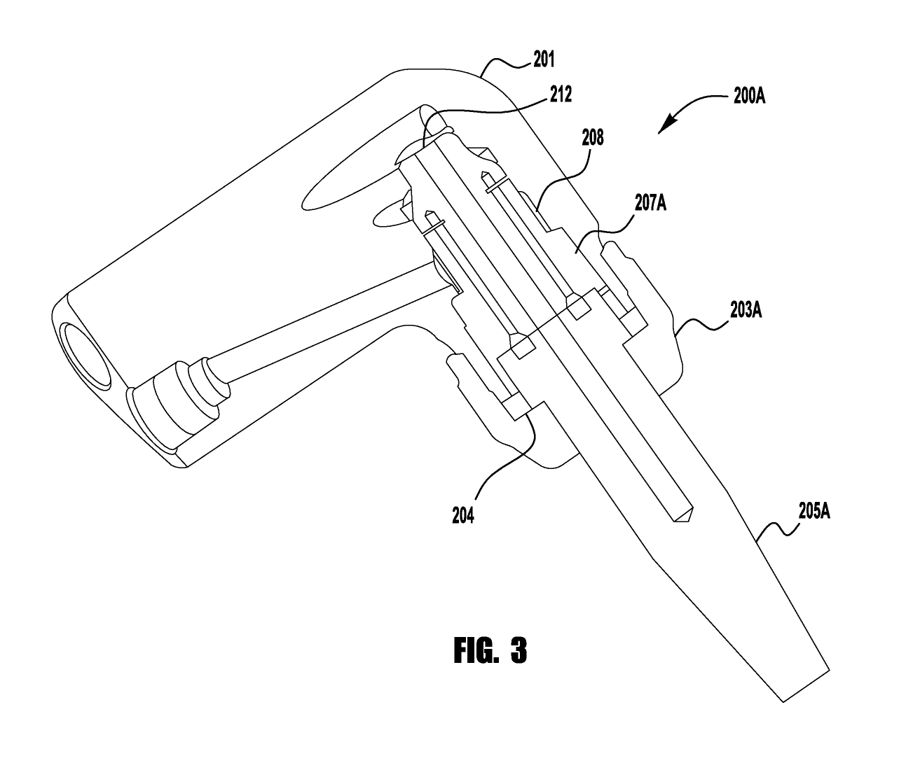

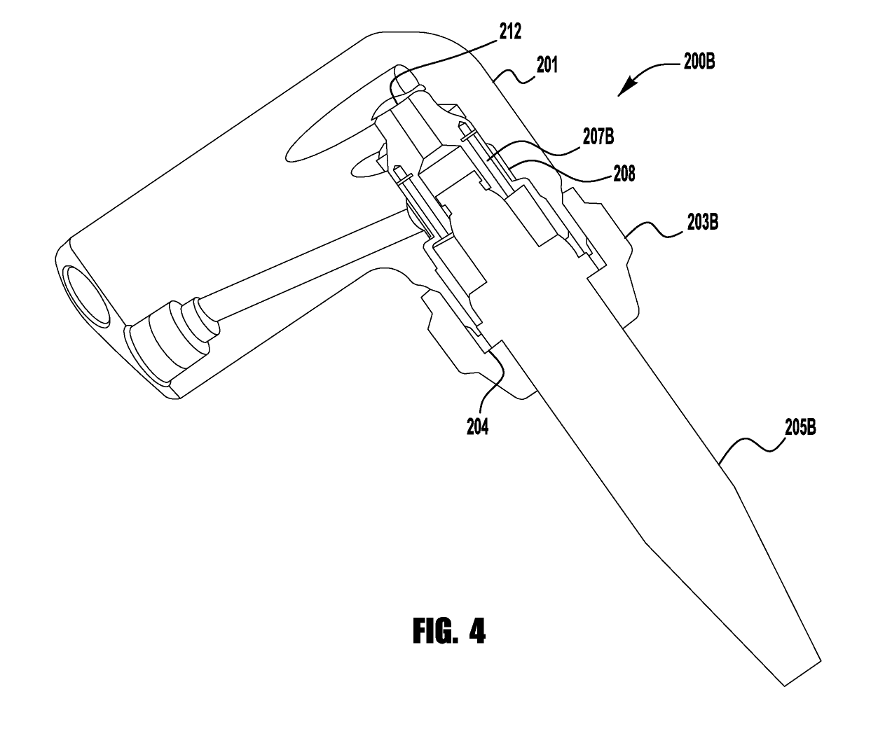

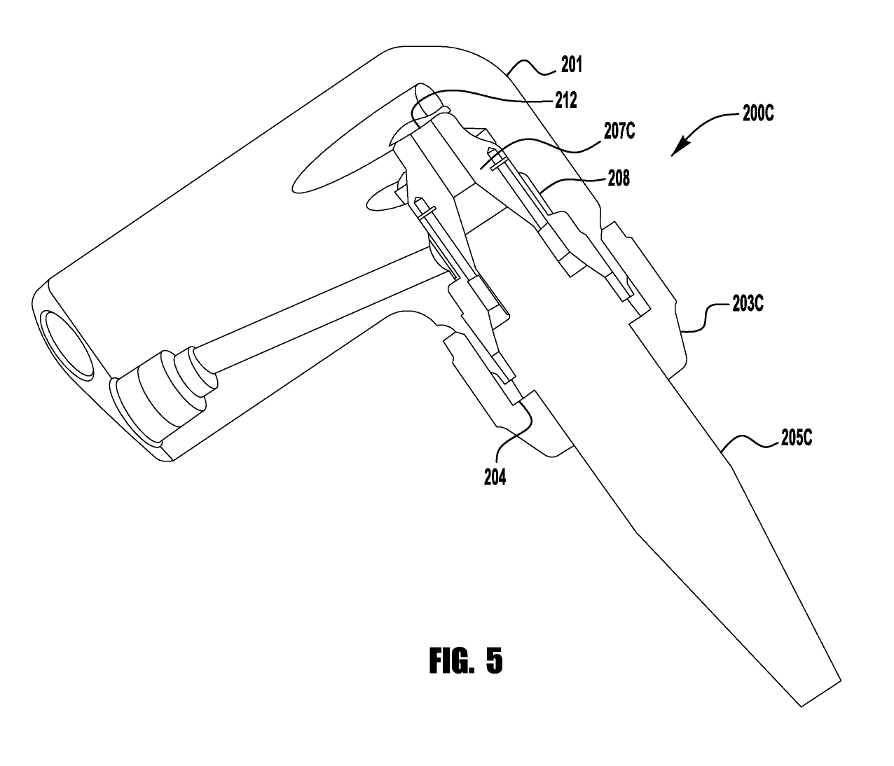

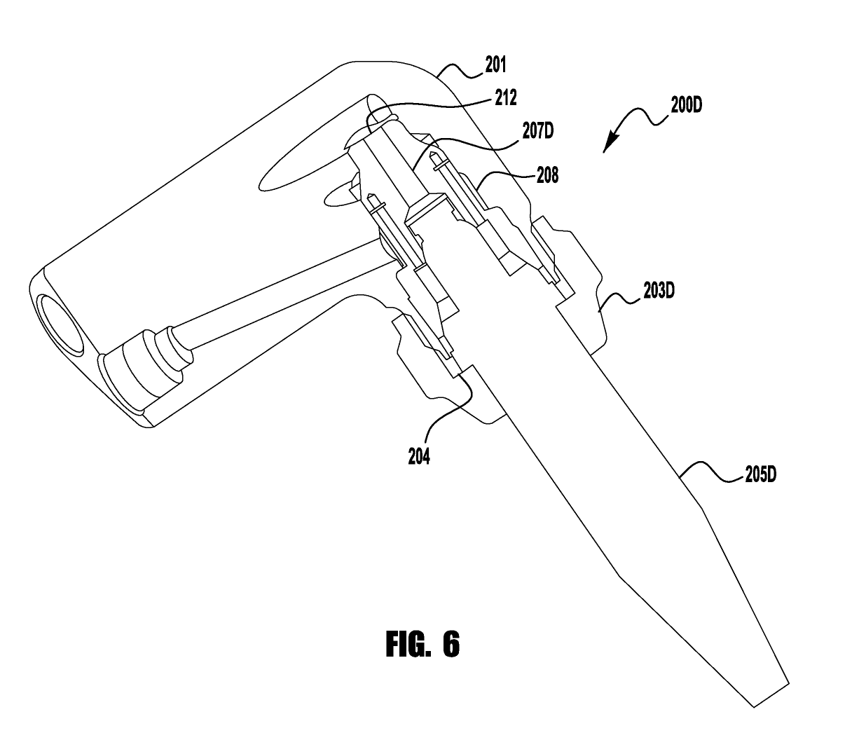

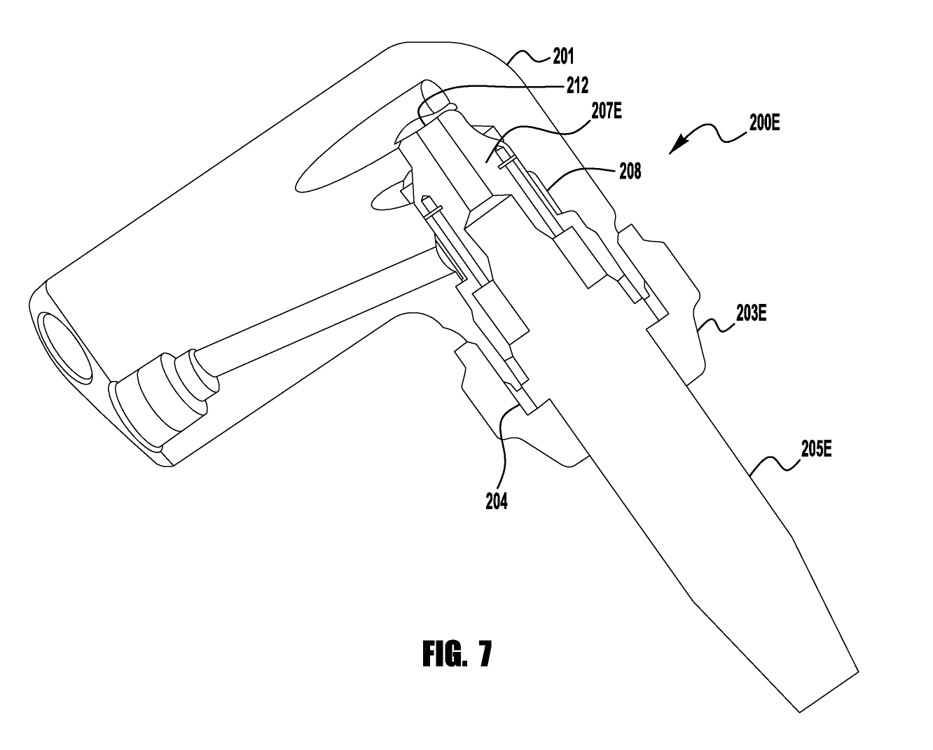

In embodiments of the present invention, the mixer 207 is configured to be insertable into the cavity 208 such that the channel 209 and passages 211 in the mixer are coupled to the appropriate channels 113, 115 and 117 in the torch head 201. The mixer 207 is also configured such that the channel 209 and passages 211 in the mixer 207 are couplable to the appropriate channels in the torch tip 205 to be used. Specifically, in exemplary embodiments of the present invention, the mixer 207 is specifically designed to be insertable into the universal cavity 208 and appropriately mate with a torch tip 205 designed for a specific cutting torch 100, and have a channel 209 and passages 211 that match with the specific torch tip 205 to be used. This is shown in the various exemplary embodiments depicted in FIGS. 3 through 7, which will be further explained below.

Further, a tip nut 203 is employed to secure the torch tip 205 and mixer 207 into the cavity 208. In FIGS. 1 and 2 the cavity 208 and tip nut 203 are configured such that the tip nut 203 is secured into the cavity 208. That is, the threads to secure the nut 203 are located on the surface of the cavity 208. However, in other exemplary embodiments the nut 203 and the body 201 are configured such that the nut 203 is secured to an outside surface of the body 201. This is shown in FIGS. 3 through 7, where the nut 203A-E is secured (via the use of threads, for example) on an outer surface of the head body 201.

In an exemplary embodiment of the present invention the tip nut 203 is universal for the various tips 205 that can be accommodated by the torch 100. However, in another exemplary embodiment the tip nut 203 can be specifically designed to accommodate and properly seat a particular set of torch tips 205 or a single torch tip 205. In any event, the nut 203 properly secures the tip 205 to the mixer 207 within the cavity 208 so as to ensure proper operation.

The tip nut 203 also contains a tip nut seat 204 which is configured to press against the torch tip 205 and hold the tip 205 and mixer 207 in the cavity 208. In exemplary embodiments of the present invention, the tip nut 203, tip nut seat 204 and the cavity 208 (as shown in FIGS. 1-2) or the body 201 are configured such that a nut 203 can be used with the universal body 201 with many different torch tips 205A-E. For example, the threads on the nut 203 and the body 201 (whether in the chamber 208 or on the outside surface of the body 201) have a sufficient thread length to allow for adaptation of the nut 203, head 201 and the many different types of torch tips 205A-E. In such a configuration, it is not necessary to change either the head 200 or the nut 203 when changing from one type of torch tip 205A-E to another. This, again, provides the advantage of providing a cutting torch 100 which can be used with multiple torch tip 205 configurations. In other embodiments, the nut 203 and the nut seat 204 are designed for a specific torch tip 205.

As shown in FIGS. 2-7 the universal cavity 208 contains a shoulder portion 210 which separates a lower portion 212 of the chamber 208 from an upper portion 214. The lower portion 212 of the chamber 208 delivers the cutting oxygen from the channel 113 to the channel 209 of the mixer 207, while the upper portion 214 of the chamber 208 delivers the fuel gas from the channel 117 and the preheat oxygen from the channel 115 to the passages 211 of the mixer 207. When installed, the mixer 207 is seated against the shoulder portion 210 to separate the lower portion 212 from the upper portion 214 during operation, and to appropriately couple to the torch tip 205 to be used.

In each of FIGS. 3-7, five different configurations are depicted to exemplify various aspects of the present invention. Specifically, in FIGS. 3-7 a torch head 200A-E is shown in which the body 201, chamber 208, shoulder 210, lower portion 212, and upper portion 214 are identical. That is, they are the same components. However, in each of FIGS. 3-7 each of the torch tips 205A-E are configured for different manufacturer's cutting torches. Specifically, the torch tips 205A-E were manufactured by different manufacturers and are designed and manufactured for different, specifically made, cutting torch heads. Because they were made for the torches of different manufacturers each of the tips 205A-E have a unique physical structure (as shown by the different outline shapes in FIGS. 3-7) and unique gas mixing profiles. This uniqueness is a function of the fact that the tips 205A-E are made for different manufacturer's cutting torches. Because of at least the physical differences in the shape of the tips 205A-E, up until now they could not be used in torches 100 from other manufacturers. This is due, at least in part, to the fact that different manufacturers use cutting torches having cutting torch heads with differently shaped cavities, such that a tip 205A-E for a different cutting torch 100 can not be used in the cavity. Because of the aspects of the present invention, this is no longer the case.

Further, the mixers 207A-E are manufactured such that they each mate with the chamber 208 and the respective torch tip 205A-E for which they are designed, such that proper operation of the head 200A-E is achieved. That is, the mixers 207A-E are configured to deliver the appropriate gases to the appropriate channel in the torch tips 205A-E while at the same time mate with the universal chamber 208.

Thus, the universal cavity 208, its shoulder 210, lower portion 212, upper portion 214 and/or the nut 203 are configured to accommodate a plurality of different torch tips 205 having different structural configurations. The exact configuration of the cavity 208, etc. is a function of the different torch tip types for which is designed to accommodate.

During operation, a cutting torch 100 is assembled as desired using the components described above. It is possible, and often likely, tat some point during use the torch tip 205 becomes damaged and it is necessary to replace the tip 205 to ensure proper cutting. At this point, the damaged torch tip 205 is removed by removal of the nut 203. Once the nut is removed then the tip 205 and the mixer 207 can be removed from the cavity 208. If the same torch tip 205 is available then the same mixer 207 can be utilized (or replaced if needed) and the same type of tip 205 can be reinstalled. In prior art cutting torches, the replacement of the same tip 205 was a necessity and if the replacement tip 205 was not available then the use of the cutting torch 205 was prohibited.

However, because of the present invention, if the same torch tip 205 is not available (due to low stock), the torch 100 can still be used with any one of a number of torch tips 205A-E which were manufactured for cutting torches 100 made by other manufacturer's. Thus, if the original type of tip 205 is not available, a user can use a different torch tip 205A-E by selecting the appropriate mixer 207A-E for the selected torch tip 205A-E and installing the appropriate mixer 207A-E and torch tip 205A-E into the cavity 208, securing both with the nut 203A-E.

For example, if a torch 100 was using tip 205A and mixer 207A and the tip and/or mixer is damaged, the user can continue to use the torch 100 by replacing the mixer 207A with anyone of a plurality of mixers 207B-E and the corresponding tip 205B-E. This greatly enhances the usability and utility of the torch 100 over prior torches which would be rendered non-functional by the unavailability of the specific tip and mixer designed for that torch 100.

It is noted that the present invention is not limited to the use of the cutting torch described herein, but can be used with in any cutting torch application consistent with the discussions and descriptions herein. For example, although a cutting torch 100 with a handle configuration is shown in FIG. 1, the present invention is not limited to torches of this configuration as a straight cutting torch configuration can be used.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A cutting torch, comprising:
a torch head, wherein said torch head comprises:
a torch head body having a universal cavity and a plurality of channels coupled to said universal cavity,
one of a plurality of mixers inserted into a bottom portion of said universal cavity;
one of a plurality of torch tips inserted into an upper portion of said universal cavity and abutted against said one of said plurality of mixers; and
wherein each of said plurality of torch tips has a unique exterior structural configuration because at least some of said plurality of torch tips were manufactured for use in a second cutting torch having a second cutting head body which has a different cavity from said universal cavity, and
wherein said one of said plurality of mixers is configured to be positioned in said lower portion and operationally mate with said one of said plurality of torch tips.

2. The cutting torch of claim 1, wherein said universal cavity has a shoulder portion which engages said one of said plurality of mixers when said one of said plurality of mixers is inserted into said universal cavity.

3. The cutting torch of claim 1, further comprising a torch tip nut engaged with said torch head body and said one of said plurality of torch tips to secure both of said one of said plurality of mixers and said one of said plurality of torch tips into said universal cavity.

4. The cutting torch of claim 3, wherein said torch tip nut is a universal torch tip nut and is configured to secure more than one of said plurality of said torch tips into said universal cavity.

5. The cutting torch of claim 1, wherein said torch head comprises a plurality of channels which are coupled to said universal cavity.

6. The cutting torch of claim 1, wherein said plurality of torch tips comprises five different torch tips.

7. A cutting torch head, comprising:
a torch head body having a universal cavity and a plurality of channels coupled to said universal cavity,
one of a plurality of mixers inserted into a bottom portion of said universal cavity;
one of a plurality of torch tips inserted into an upper portion of said universal cavity and abutted against said one of said plurality of mixers; and
wherein each of said plurality of torch tips has a unique exterior structural configuration because at least some of said plurality of torch tips were manufactured for use in a cutting torch having a second cutting head body which has a different cavity from said universal cavity, and
wherein said one of said plurality of mixers is configured to be positioned in said lower portion and operationally mate with said one of said plurality of torch tips.

8. The cutting torch of claim 7, wherein said universal cavity has a shoulder portion which engages said one of said plurality of mixers when said one of said plurality of mixers is inserted into said universal cavity.

9. The cutting torch of claim 7, further comprising a torch tip nut engaged with said torch head body and said one of said plurality of torch tips to secure both of said one of said plurality of mixers and said one of said plurality of torch tips into said universal cavity.

10. The cutting torch of claim 9, wherein said torch tip nut is a universal torch tip nut and is configured to secure more than one of said plurality of said torch tips into said universal cavity.

11. The cutting torch of claim 7, wherein said torch head comprises a plurality of channels which are coupled to said universal cavity.

12. The cutting torch of claim 7, wherein said plurality of torch tips comprises five different torch tips.
